(19) United States
(12) Patent Application Publication
(10) Pub. No.: US 2005/0245422 A1
(43) Pub. Date: Nov. 3, 2005

(54) Alkali cleaner

(76) Inventors: Yasuhiro Yamada, Higashiyama-ku (JP); Koji Kawaguchi, Higashiyama-ku (JP)

Correspondence Address: J.C. Patents;Suite 250, 4 Venture, Irvine, CA, 92618, US

(21) Appl. No.: 11/114,995

(22) Filed: Apr. 25, 2005

(30) Foreign Application Priority Data
Apr. 30, 2004 (JP) 2004-136096

(51) Int. Cl. C11D 17/00

(52) U.S. Cl. 510/417; 510/504

(57) ABSTRACT

An alkali cleaner is described, including an alkali component (A), a polyvalent alcohol (B) of 3 to 8 valent containing no nitrogen atom and having a Mn of 92-400, and an alcohol (C). The alcohol (C) includes at least one alcohol selected from the group consisting of a divalent alcohol (C1) containing no nitrogen atom and having a Mn of 62-250 and a monovalent alcohol (C2) containing no nitrogen atom and having a Mn of 32-500.

### CROSS-REFERENCE TO RELATED APPLICATION

This application claims the priority benefit of Japanese application serial no. 2004-136096, filed on Apr. 30, 2004. All disclosure of the Japanese application is incorporated herein by reference.

### BACKGROUND OF THE INVENTION

1. Field of the Invention

The present invention relates to an alkali cleaner that is used to remove grease, resin or particles, etc. adhering to electronic parts, metal parts or ceramic parts, etc. More particularly, the present invention relates to an alkali cleaner that is used as a stripping solution for a vertical alignment polyimide film, particularly a semi-baked film, of a liquid crystal display (LCD) panel, or as a stripping solution for a photoresist material used in the manufacture of semiconductor device circuits or semiconductor device circuits of a LCD panel.

2. Description of the Related Art

Conventionally, an alkali cleaner is superior than a neutral cleaner in removing grease, resin or particles, etc., and thereby is widely used in manufacturing sites of electronic parts, metal parts or ceramic parts. However, because an alkali cleaner easily corrodes a non-iron metal like aluminum (Al), it currently cannot be used to clean an Al-containing part, for example, an electronic part that has a portion or all portions containing aluminum. An example of cleaning an electronic part, particularly an LCD panel, is described below. Up until now, polyimide alignment films of LCD panels are mostly the horizontal alignment type; however, vertical alignment polyimide films are used more and more to meet the requirement of large view angle for LCD panels. When the horizontal alignment polyimide films on glass substrates are in a semi-baked state as semi-cured films after solvent removal at 80° C. but before full baking at 180° C., the unqualified semi-products can be treated with a solvent like N-methylpyrrolidone to strip the alignment films without corroding the aluminum film or lines. However, in the cases of the vertical alignment polyimide films, the alignment films cannot be stripped by the neutral solvent even in the semi-baked state, and alkali solvent has to be used, as described in the Japanese Patent Application Laid Open No. Hei 6-306661. In one method used for such cases of removing alignment films, the cleaning step is performed after the areas of the Al film or lines on the glass substrate is protected by wax to prevent corrosion of the Al film or lines, and then a solvent, such as a hydrocarbon solvent, is applied to remove the wax to regenerate the substrate. Another method is to strip/dissolve the Al film completely together with the alignment film to regenerate the glass substrate only.

Moreover, in a fabricating process of semiconductor device circuit, an amine-type stripper is conventionally used to remove photoresist residues that are generated during the formation of conductive lines. However, the amine-type stripper easily corrodes the metal lines or metal film made from aluminum or tungsten, etc. on the substrate. To solve the problem, an aqueous solution containing quarternary ammonium hydroxide and saccharide is proposed to use as a photoresist stripper, in which corrosion of metal lines or film can be avoided, as described in, for example, the Japanese Patent Application Laid Open No. Hei 4-48633. However, such a photoresist stripper cannot simultaneously fulfill stripping of the photoresist and inhibition of corrosion of metal lines.

### SUMMARY OF THE INVENTION

Accordingly, one object of this invention is to provide a new cleaner being superior in inhibiting corrosion of metal (especially aluminum), a cleaning method using the cleaner, and an electronic part having been cleaned with the cleaner.

Specifically, this invention provides an alkali cleaner that includes an alkali component (A), a polyvalent alcohol (B) and an alcohol (C). The polyvalent alcohol (B) has a valent number of 3-8, containing no nitrogen atom and having a number average molecular weight (Mn) of 92-400. The alcohol (C) includes at least one alcohol selected from the group consisting of a divalent alcohol (C1) and a monovalent alcohol (C2), wherein the divalent alcohol (C1) contains no nitrogen atom and has a Mn of 62-250, and the monovalent alcohol (C2) contains no nitrogen atom and has a Mn of 32-500. This invention also provides a method for cleaning an electronic part, an electric part or an aluminum building material, which uses the above cleaner and at least one cleaning method selected from ultrasonic cleaning, shower cleaning, spray cleaning, dipping cleaning and dipping-shaking cleaning. This invention further provides an electronic part, an electric part or an aluminum building material that has been cleaned with the above cleaning method, rinsed, and then dried.

Since the cleaner of this invention is superior in preventing corrosion of metal (particularly Al), for a glass substrate of LCD panel or a semiconductor substrate, for example, the semi-baked vertical alignment polyimide film or photoresist can be stripped/cleaned in short time without damaging the aluminum lines and the color filter parts. Therefore, not only the glass substrate is regenerated through the stripping/cleaning process of the alignment film, i.e., the regeneration process of the glass substrate, as in the prior art, the aluminum lines and color filter parts are also regenerated at the same time. Moreover, the cleaner of this invention is also superior in the capability of removing oils, finger print, resin and particles.

It is to be understood that both the foregoing general description and the following detailed description are exemplary, and are intended to provide further explanation of the invention as claimed.

### DESCRIPTION OF THE PREFERRED EMBODIMENTS

In this invention, examples of the alkali component (A) include: metal hydroxides (A1), such as, alkali metal hydroxides like LiOH, NaOH and KOH, etc., and alkali earth metal hydroxides like Ca(OH)₂, Mg(OH)₂ and Ba(OH)₂, etc.; carbonate salts (A2), such as, alkali metal carbonates like Na₂CO₃ and K₂CO₃, etc., and alkali earth metal carbonates like CaCO₃, MgCO₃ and BaCO₃, etc.; phosphate salts (A3), such as, alkali metal phosphates like sodium pyrophosphate, potassium pyrophosphate, sodium tripolyphosphate and potassium tripolyphosphate, etc., and alkali earth metal phosphates like calcium pyrophosphate, magnesium pyrophosphate, barium pyrophosphate, calcium tripolyphosphate, magnesium tripolyphosphate and barium tripolyphosphate, etc.; silicate salts (A4), such as, alkali metal silicates like sodium silicate and potassium silicate, etc., and alkali earth metal silicates like calcium silicate, magnesium silicate and barium silicate, etc.; ammonia (A5); hydroxylamine (A6); and the organic alkali (A7) expressed by general formula (1) below: 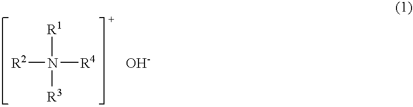 —R⁵O)ₚ—H (2)
wherein R¹ represents a hydrocarbon group of C1-24, preferably C1-14. Each of R², R³ and R⁴ represents a hydrogen atom, a hydrocarbon group of C1-24 (preferably C1-14) or a group expressed by general formula (2) above, wherein R₅ represents an alkylene group of C2-4 and p is an integer of 1-6. Mixtures of the above compounds are also applicable.

In general formula (1), R¹ may be a straight or branched, saturated or unsaturated hydrocarbon group, an alicyclic hydrocarbon group or a hydrocarbon group containing an aromatic ring, etc.

Examples of the straight or branched saturated hydrocarbon group include alkyl groups, such as, methyl, ethyl, n-, i-, sec- and t-butyl, octyl, 2-ethylhexyl and octadecyl, etc. Examples of the straight or branched unsaturated hydrocarbon group include alkenyl groups, such as, vinyl, propenyl, allyl and butenyl, etc. Examples of the alicyclic hydrocarbon group include cycloalkyl groups like cyclohexyl. Examples of the hydrocarbon group containing an aromatic ring include: aryl groups like phenyl and naphthyl, etc.; aralkyl groups like benzyl and phenethyl, etc.; alkylaryl groups like methylphenyl, ethylphenyl, nonylphenyl, methylnaphthyl and ethylnaphthyl, etc.

Among the above hydrocarbon groups, alkyl groups and alkenyl groups are preferred in consideration of the cleaning effect.

When the carbon number of R¹ is 24 or less, the cleaning effect (or stripping effect, hereinafter) is good. When R², R³ and R⁴ are all hydrocarbon groups, examples thereof include the same hydrocarbon groups exemplified for R¹, while the preferable hydrocarbon groups are also the same as in the case of R¹. The cleaning effect is desirable as the carbon number of each of R², R³ and R⁴ is 24 or less.

In general formula (2), R⁵ may be an alkylene group of C2-4 like ethylene, propylene and butylene, etc.

When the carbon number of R⁵ is 4 or less, the cleaning effect is good. The value of p is an integer of 1-6, preferably 1-3. When p is 6 or less, the cleaning effect is good.

Examples of the organic alkali (A7) include salts of OH⁻ and organic cations having at least one hydrocarbon group bonded to a nitrogen atom as described in the following items (1)-(5), and mixtures thereof.

(1) Quarternary ammonium cations having 4 hydrocarbon groups, including:
tetrahydrocarbyl ammonium containing 4 alkyl groups of C1-6, such as, tetramethyl ammonium, tetraethyl ammonium, tetra-(n or i)-propyl ammonium, tetra-(n, i or t)-butyl ammonium, tetrapentyl ammonium and tetrahexyl ammonium, etc.;
tetrahydrocarbyl ammonium containing 3 alkyl groups of C1-6, such as, trimethylheptyl ammonium, trimethyloctyl ammonium, trimethyldecyl ammonium, trimethyldodecyl ammonium, trimethylstearyl ammonium, trimethylbenzyl ammonium, triethylhexyl ammonium, triethyloctyl ammonium, triethylstearyl ammonium, triethylbenzyl ammonium, tributylbenzyl ammonium, tributyloctyl ammonium and trihexylstearyl ammonium, etc.;
tetrahydrocarbyl ammonium containing 2 alkyl groups of C1-6, such as, dimethyldioctyl ammonium, diethyldioctyl ammonium and dimethyldibenzyl ammonium, etc.; and
tetrahydrocarbyl ammonium containing one alkyl group of C1-6, such as, methyltrioctyl ammonium, ethyltrioctyl ammonium and methyloctyldibenzyl ammonium, etc.

(2) Tertiary amine cations having 3 hydrocarbon groups, including:
trihydrocarbylamine cations containing 3 alkyl groups of C1-6, such as, trimethylamine cation, triethylamine cation and tributylamine cation, etc.;
trihydrocarbylamine cations containing 2 alkyl groups of C1-6, such as, dimethyloctylamine cation, dimethylstearylamine cation, diethyloctylamine cation, dibutyloctylamine cation and dimethylbenzylamine cation; and
trihydrocarbylamine cations containing one alkyl group of C1-6, such as, methyldioctylamine cation, ethyldioctylmine cation and methyloctylbenzylamine cation, etc.

(3) Secondary amine cations having 2 hydrocarbon groups, including:
dihydrocarbylamine cations containing 2 alkyl groups of C1-6, such as, dimethylamine cation, diethylamine cation, dibutylamine cation and dihexylamine cation, etc.; and
dihydrocarbylamine cations containing one alkyl group of C1-6, such as, methyloctylamine cation, ethyloctylamine cation, butyloctylamine cation, hexyloctylamine cation, methylstearylamine cation, methylbenzylamine cation and ethylbenzylamine cation, etc.

(4) Primary amine cations having one hydrocarbon group, including:
monohydrocarbyl amine cation of C1-6, such as, methylamine cation, ethylamine cation, butylamine cation and hexylamine cation, etc.

(5) Cations containing oxyalkylene group(s), including:
(i) cations having one oxyalkylene group, such as, hydroxyethyltrimethylamine cation, hydroxyethyltriethylamine cation, hydroxypropyltrimethylamine cation, hydroxypropyltriethylamine cation, hydroxyethyldimethylethylamine cation and hydroxyethyldimethyloctylamine cation, etc.;
(ii) cations having 2 oxyalkylene groups, such as, dihydroxyethyldimethylamine cation, dihydroxyethyldiethylamine cation, dihydroxypropyldimethylamine cation, dihydroxypropyldiethylamine cation, dihydroxyethylmethylethylamine cation, dihydroxyethylmethyloctylamine cation and bis(2-hydroxyethoxyethyl)octylamine cation, etc.; and
(iii) cations having 3 oxyalkylene groups, such as, trihydroxyethylmethylamine cation, trihydroxyethylethylamine cation, trihydroxyethylbutylamine cation, trihydroxypropylmethylamine cation, trihydroxypropylethylamine cation and trihydroxyethyloctylamine cation, etc.

Among the above alkali components (A), species (A1) and (A7) are preferred in consideration of the cleaning effect and rinsability. Alkali metal oxides are preferred among (A1) when considering the cleaning effect, wherein NaOH and KOH are more preferable. Among (A7), the salts of the cations described in above items (1) and (2) are preferred in consideration of the cleaning effect and rinsability, wherein the salts of the cations in item (1) are more preferable. Among the salts of the cations in item (1), tetraalkylammonium hydroxide compounds containing 4 alkyl groups of C1-6 are still more preferable, wherein tetramethylammonium hydroxide and tetraethylammonium hydroxide are even more preferable. In addition, a mixture of the above compounds can also be used.

Examples of the polyvalent alcohol (B) of 3 to 8 valent containing no nitrogen atom and having a number average molecular weight (Mn, measured through gel permeation chromatography [GPC]) of 92-400 of this invention include: aliphatic polyalcohols of 3 to 8 valent like glycerin, trimethylolethane, trimethylolpropane, diglycerin, triglycerin, tetraglycerin, pentaglycerin, 2-methylglycerin, 1,2,4-butanetriol, saccharose, glucose, fructose, ribose, maltose, trehalose, xylose, erythritol, xylitol, sorbitol, mannitol and sucrose, etc.; and alkyleneoxide-adducts of the above compounds with 1-7 alkyleneoxide groups of C2-3.

Among the above polyvalent alcohols (B), glycerin, diglycerin, triglycerin and sorbitol are preferred in consideration of the cleaning effect and rinsability.

Examples of the divalent alcohol (C1) containing no nitrogen atom and having a Mn of 62-250 of this invention include: alkanediols, such as, alkanediols of C2-8 like ethyleneglycol, 1,2-propyleneglycol, 1,3-propyleneglycol, 1,4-butanediol, 1,6-hexanediol and neopentylglycol, etc.; alicyclic diols, such as, alicyclic diols of C6-15 like cyclohexane-1,2-, 1,3- and 1,4-diol, cyclopentane-1,2- and 1,3-diol, and hydrogenated bisphenol A, etc.; diols having one ether group therein, such as, diethyleneglycol and dipropyleneglycol, etc.; and mixtures of the same. The Mn of (C1) preferably satisfies the inequality of “62<Mn_{C1}<150”.

Examples of the monovalent alcohol (C2) containing no nitrogen atom and having a Mn of 32-500 of this invention include: aliphatic alcohols of C1-12, adducts of the same with alkyleneoxide groups of C2-4, and mixtures thereof. Specific examples of the aliphatic alcohol of C1-12 include methanol, ethanol, isopropanol and butanol, etc. Examples of adducts of the alcohols with alkyleneoxide groups of C2-4 include ethyleneglycol monomethyl ether, diethyleneglycol monomethyl ether, propyleneglycol monomethyl ether and diethyleneglycol monobutyl ether, etc.

Among the above compounds (C), ethyleneglycol, propyleneglycol and dipropyleneglycol among (C1) and ethyleneglycol monomethyl ether and diethyleneglycol monomethyl ether among (C2) are preferred when in consideration of the cleaning effect and the corrosion prevention effect, wherein propyleneglycol and diethyleneglycol monomethyl ether are more preferable.

Moreover, in consideration of the cleaning effect and the corrosion prevention effect, respective amounts of the components (A), (B) and (C) in the cleaner of this invention on the basis of the total amount of (A), (B) and (C) are given as follows. The amount of (A) is preferably 0.1-25% (“%” means “weight %”, hereinafter) and more preferably 0.2-15%. The amount of (B) is preferably 1-25% and more preferably 2-15%. The amount of (C) is preferably 60-95% and more preferably 75-93%. The weight ratio of (A) to (B) is preferably 10/90 to 99/1, more preferably 20/80 to 80/20, in consideration of the cleaning effect and the corrosion prevention effect.

Except the components (A), (B) and (C), the cleaner of this invention may further include at least one of a surfactant (D), a hydrophilic solvent (E) containing an amide group, other additives (F) and water.

Examples of the surfactant (D) include: nonionic surfactant (D1), anionic surfactant (D2), cationic surfactant (D3), amphoteric surfactant (D4) and mixtures thereof. However, (D1) excludes the alcohols in the scopes of (B) and (C), and (D3) excludes the organic alkali expressed by general formula (1).

Examples of the nonionic surfactant (D1) include alkyleneoxide-added type nonionic surfactants and polyalcohol (C3-20) type nonionic surfactants. The alkyleneoxide-added type nonionic surfactants include: adducts with Mn of 158-200,000 obtained by directly adding alkyleneoxide groups of C2-4 like ethyleneoxide (EO), propyleneoxide or butyleneoxide to higher alcohol of C8-18, alkylphenol of C 10-24, higher aliphatic acid of C 12-24 or higher alkylamine of C8-24; reaction products of polyoxyalkyleneglycol with Mn of 150-6,000 with higher aliphatic acid of C12-24; alkyleneoxide adducts with Mn of 250-30,000 formed by adding alkyleneoxide groups to an esterfied compound that is obtained from the reaction of a higher aliphatic acid of C12-24 with a compound having hydroxyl groups like a diol as exemplified above for (C1) or like a polyalcohol of 3 to 8 valent as exemplified above for (B); adducts (Mn=200-30,000) of amide of higher aliphatic acid of C8-24 with alkyleneoxide groups; and adducts (Mn=120-30,000) of alkyl (C8-60) ether of the above polyalcohol with alkyleneoxide groups. The polyalcohol type nonionic surfactants include aliphatic acid (C8-60) ester of polyalcohol, alkyl (C8-60) ether of polyalcohol, and alkanolamide of aliphatic acid of C8-60, etc.

Examples of anionic surfactant (D2) include: carboxylic acids like saturated or unsaturated aliphatic acids of C8-22, and salts thereof; salts of carboxymethylated compound like the carboxymethylated product of an aliphatic alcohol of C8-16 and/or an EO-adduct thereof with 1-10 mole EO groups; salts of sulfate ester, such as, salts of sulfate ester of higher alcohol like aliphatic alcohol of C8-18; salts of sulfate ester of higher alkyl ether like an EO-adduct of an aliphatic alcohol of C8-18 with 1-10 mole EO groups; sulfated oil like the salt obtained by directly sulfating and then neutralizing natural unsaturated lipid or unsaturated wax; sulfated aliphatic ester like the salt obtained by sulfating an then neutralizing lower alcohol ester of unsaturated aliphatic acid; sulfated olefin like the salt obtained by sulfating and then neutralizing olefin of C12-18; sulfonate salts like alkylbenzenesulfonate salts, alkylnaphthalenesulfonate salts, sulfosuccinate diester-type surfactants, α-olefinsulfonate salts with α-olefin of C12-18 and Igepon T-type surfactants, etc.; and salts of phosphate ester like salts of phosphate ester of higher alcohol of C8-60, salts of phosphate ester of EO-adduct of higher alcohol of C8-60 and salts of phosphate ester of EO-adduct of alkylphenol with alkyl of C4-60, etc. In addition, the counter cation of the above salts may be cation of alkali metal like Na and K, etc., cation of alkali earth metal like Ca and Mg, etc., ammonium ion, cation of alkylamine of C1-20, or cation of alkanolamine of C2-12 like mono-, di- or tri- ethanolamine, etc.

Examples of cationic surfactant (D3) include quarternary ammonium salt type surfactants and amine salt type surfactants, etc. The quarternary ammonium salt type surfactants include: tetraalkylammonium salts with alkyl of C4-100, like lauryltrimethylammonium chloride, didecyldimethylammonium chloride, dioctyldimethylammonium chloride and stearyltrimethylammonium chloride; trialkylbenzylammonium salts with alkyl of C3-80, like lauryldimethylbenzylammonium chloride (benzalkonium chloride); alkylpyridinium salts with alkyl of 2-60, like cetylpyridinium chloride; polyoxyalkylenetrialkylammonium salts with alkylene of C2-4, like polyoxyethylenetrimethylammonium chloride; and Sapamine-type quarternary ammonium salts like stearamideethyldiethylmethylammonium methosulfate. The amine salt type surfactants include: organic acid salts and inorganic acid salts of higher aliphatic amine, wherein examples of the inorganic acid include hydrochloric acid, sulfuric acid, nitric acid and phosphoric acid, etc., examples of the organic acid include organic acids of C2-22 like acetic acid, propionic acid, lauric acid, oleic acid, benzoic acid, succinic acid, adipic acid and azelaic acid, etc., and examples of the higher aliphatic amine include aliphatic amines of C12-60 like laurylamine stearylamine, cetylamine, hardened beef-tallow amine and rosin amine, etc.; higher aliphatic acid salts of lower amine of C1-11, wherein examples of the higher aliphatic acid include aliphatic acids of C12-24 like stearic acid and oleic acid; inorganic acid salts and organic acid salts of EO-adducts of aliphatic amine of C1-30, wherein examples of the inorganic acid and organic acid are the same as above; and inorganic acid salts and organic acid salts of tertiary amine like triethanolamine monostearate and stearamideethyldiethylmethylethanolamine, etc., wherein examples of the inorganic acid and organic acid are the same as above.

Examples of amphoteric surfactant (D4) include: amino acid-type amphoteric surfactants like sodium propionate of higher alkylamine of C12-18; Betain-type amphoteric surfactants like alkyldimethyl betain with alkyl of C 12-18, alkyldihydroxyethyl betain with alkyl of C12-18, and coconut oil aliphatic acid amide-propyl betain, etc.; sulfate ester salt type amphoteric surfactants, like sodium salt of sulfate ester of higher alkylamine with alkyl of C8-18 and sodium salt of hydroxyethylimidazoline sulfate ester, etc.; sulfonate salt type amphoteric surfactants like pentadecylsulfotaurine and imidazoline sulfonic acid, etc.; and phosphate ester salt type amphoteric surfactants like amine salts of phosphate ester of higher aliphatic acid (C8-22) ester of glycerin.

Among the above surfactants (D1)-(D4), species (D1) and (D2) are preferred in consideration of the cleaning effect and the corrosion prevention effect, wherein (D1) is more preferable. The amount of (D) on the basis of the total amount of the cleaner is usually 30% or less, preferably 1-20%.

The hydrophilic solvent (E) having an amide group is defined as a water-soluble amide that contains one or more amide groups and has a solubility (g/100 g) higher than 3 in water at 20° C., such as, 2-pyrrolidone and N-alkyl-2-pyrrolidone with alkyl of C1-3, etc. Considering the cleaning effect and rinsability, N-methyl-2-pyrrolidone, N-ethyl-2-pyrrolidone, N-n-propyl-2-pyrrolidone and N-isopropyl-2-pyrrolidone are preferred, wherein N-methyl-2-pyrrolidone is more preferable. The amount of (E) on the basis of the total amount of the cleaner is preferably 30% or less, more preferably 1-20%, in consideration of the cleaning effect, rinsability and the corrosion prevention effect.

The amount of water on the basis of the total amount of the cleaner is preferably 39% or less, more preferably 1-38% and particularly preferably 2-30%, in consideration of the cleaning effect, rinsability and the corrosion prevention effect.

Examples of other additives (F) include: anti-rust agents, such as, EO-adducts of amine of C6-30 like cyclohexylamine, laurylamine and stearylamine, etc., with 2-10 mole EO groups, chromate salts, nitrite salts, higher aliphatic acid (C8-30) salts of amine of C6-30, alkali metal (e.g., Na or K, etc.) salts, ammonium salts and alkanolamine salts (e.g., triethanolamine salts) of dicarboxylic acid of C12-24, alkanolamide of dicarboxylic acid of C12-24 (e.g., dodecenylsuccinic acid diethanolamide), alkali metal salts of alkanolamide of dicarboxylic acid of C12-24 (e.g., sodium salt of dodecenylsuccinic acid diethanolamide), etc.; antioxidants, such as, phenol compounds like 2,6-di-t-butyl-4-methylphenol, sulfur-containing compounds like dilaurylthiodipropionate, amine compounds like octylated diphenylamine, and phosphorous compounds like triphenylphosphite, etc.; metal ion chelating agents like sodium ethylenediaminetetraacetate (EDTA) and sodium citrate, etc.; and organic acids like citric acid, glycolic acid, succinic acid, tartaric acid, lactic acid, fumaric acid, malic acid, levulinic acid, butyric acid, valeric acid, oxalic acid, maleic acid and mandelic acid, etc., and alkali metal (e.g., Na and K, etc.) salts, ammonium salts and alkanolamine salts (e.g., triethanolamine salts) of the organic acids.

As for the amounts of the above additives (F) on the basis of the total amount of the cleaner, the amount of the anti-rust agent is usually 20% or less, preferably 0.5-10%; the amount of the antioxidant is usually 5% or less, preferably 0.1-1%; the amount of the metal ion chelating agent is usually 20% or less, preferably 0.5-10%; and the amount of the organic acid is usually 20% or less, preferably 0.5-10%.

Moreover, the sum of the amounts of (D), (E) and (F) on the basis of the total amount of the cleaner of this invention is usually 40% or less, preferably 30% or less and more preferably 20% or less.

The viscosity of the cleaner of this invention at 25° C. is usually 2-300 mm²/s, and, in consideration of the cleaning effect and rinsability, is preferably 3-100 mm²/s and more preferably 4-50 mm²/s. The viscosity can be measured using an Ostwald viscometer or Ubbelohde viscometer, etc. The pH value of the cleaner of this invention as an aqueous solution of 10% is usually 10-14, and, in consideration of the cleaning effect and the corrosion prevention effect, is preferably 10.5-13.5.

The cleaner of this invention is not particularly limited in its uses, and can be widely used to clean various electronic parts, electric parts and aluminum building materials, preferably electronic parts, and particularly preferably the electronic parts that have a portion or all portions using aluminum. Examples of suitable electronic part include: glass substrate of LCD panel to be cleaned before the patterning step of the alignment film or to be cleaned for stripping the unqualified alignment film, semiconductor substrate, printed circuit board (PCB), glass substrate of plasma display, and thermal head, etc. Examples of suitable electric parts include: cooling fins of air conditioner, aluminum electrode plates of air purifier, and blades of electric shaver, etc. Moreover, the subjects (contaminations) that can be removed with the cleaner include: organic substances like oil, finger print, resin and organic particles, etc.; and inorganic substances, such as, inorganic particles like glass powder, ceramic powder and metal powder, etc. The cleaner is more preferably used to clean, among the above parts and materials that are suitably cleaned with the cleaner, glass substrate of LCD panel that is to be cleaned before the patterning step of the alignment film or to be cleaned for stripping the unqualified alignment film.

When the cleaner of this invention is used, for example, to strip/clean the alignment film on a glass substrate of LCD panel, the cleaning method suitably used can be ultrasonic cleaning, shower cleaning, spray cleaning, dipping cleaning, dipping-shaking cleaning, or a combination thereof. In a cleaning process, the cleaner of this invention may be diluted with water as required, while the amount of water is preferably within the above-mentioned range.

The cleaning temperature is usually 10-70° C., preferably 15-60° C. The cleaning time is usually 0.2-120 minutes, preferably 0.5-30 minutes. The water-rinsing temperature is usually 5-90° C., preferably 10-70° C., while the rinsing method can be the same as the cleaning method. After the rinsing step, the glass substrate is heated/dried usually at 50-150° C., preferably at 60-100° C., for usually 1-120 minutes, preferably 3-60 minutes, so that a clean glass substrate of LCD panel can be obtained and reused.

This invention is further explained with the following examples below, but which are not to be construed as limiting the scope of the invention. In addition, the term “part” means “weight part” in the following descriptions.

### EXAMPLES 1-8 AND COMPARATIVE EXAMPLES 1-4

For each Example or Comparative Example, the corresponding components with part numbers (shown as percentages) as listed in Table 1 are stir-mixed sufficiently in a beaker of IL at room temperature to produce the cleaner of the example. In Table 1, “A-1” represents NaOH, “A-2” represents tetra-n-butylammonium hydroxide, “A-3” represents tetraethylammonium hydroxide, “B-1” represents glycerin, “B-2” represents diglycerin, “B-3” represents sorbitol, “C-1” represents propyleneglycol, “C-2” represents ethyleneglycol, and “C-3” represents diethyleneglycol monomethyl ether.

The methods of evaluating/testing the cleaners from the Examples and the Comparative Examples are described as follows, and the evaluation results are listed in Table 1.
1. Stripping Effect to Alignment film:

In each example, a glass substrates of 25 mm×25 mm and 0.75 mm in thickness, on which an indium tin oxide (ITO) film has been formed previously, is coated with polyimide resin and then subjected to a baking treatment at 80° for three times, so that a glass substrate test plate tightly coated with a semi-baked vertical alignment polyimide film of 5 μm in thickness is obtained. After the test plate is dipped in a cleaner at 25° C. for a predetermined time period, it is placed on a stainless steel net and rinsed with shower of ion-exchange water for one minute, while the opposite surface of the test plate is also rinsed similarly. Then, the test plate is dried in an air-circulating drier at 70° C. for 10 minutes, and is observed with a microscope to evaluate the stripping effect of the corresponding cleaner to the alignment film in five grades:

<Evaluation Standard>

5: No alignment film on the glass substrate
4: Trace of alignment film remaining on the glass substrate
3: Small amount of alignment film remaining on a portion of the glass substrate
2: Alignment film remaining on most of the glass substrate

1: Alignment film remaining on all of the glass substrate

2. Stripping Effect to Photoresist

In each example, a silicon wafer of 3 inches, on which a positive photoresist material (Novalak resin) has been coated in a thickness of 2 μm, is subjected to baking at 80° C. for 10 minutes to fabricate a test plate. After the test plate is dipped in a cleaner at 50° C. for a predetermined time period, it is rinsed with shower of ion-exchange water for one minute. Next, the test plate is dried in an air-circulating drier at 70° C. for 10 minutes, and is observed with a microscope to evaluate the stripping effect of the corresponding cleaner to photoresist in five grades:

<Evaluation Standard>
5: No photoresist on the wafer surface
4: Trace of photoresist remaining on the wafer surface
3: Small amount of photoresist remaining on a portion of the wafer surface
2: Photoresist remaining on most of the wafer surface
1: Photoresist remaining on all of the wafer surface
   3. Corrosion Prevention Effect

In each example, a glass substrate test plate of 25 mm×25 mm and 0.75 mm in thickness, which has been coated with an aluminum film of 0.1 μm in thickness, is dipped in a cleaner at 40° C. for a predetermined time period, while the time for the aluminum film to be removed completely to make the test plate transparent is measured as a corrosion time of the corresponding cleaner. The longer the corrosion time, the better the corrosion prevention effect of the cleaner is.

4. Corrosion Prevention Effect (Type 2)

In each example, an aluminum test plate of 20 mm×50 mm and 1 mm in thickness is dipped in a cleaner and placed therein at 50° C. for one week. Thereafter, the test plate is rinsed and then dried at 90° C. for 30 minutes, followed by a weight measurement. A corrosion rate (mdd) is calculated using the following equation:
Corrosion rate (mdd)=(weight(mg)before dipping−weight after dipping)/[(surface area(dm²) of dipped portion of test plate)×number of days].

TABLE 1

| | | Examples of this Invention | | | | | | | | Comparative Examples | | | |
|---|---|---|---|---|---|---|---|---|---|---|---|---|---|
| | | 1 | 2 | 3 | 4 | 5 | 6 | 7 | 8 | 1 | 2 | 3 | 4 |
| A | A-1 | 4 | — | — | — | — | — | — | — | 4 | 4 | — | — |
| | A-2 | — | 3 | — | 4 | 4 | 2 | — | — | — | — | — | — |
| | A-3 | — | — | 3 | — | — | — | 3 | 6 | — | — | 4 | 4 |
| B | B-1 | 6 | 6 | — | 7 | 5 | 5 | — | — | 80 | 5 | — | — |
| | B-2 | — | — | 3 | — | — | — | — | — | — | — | — | — |
| | B-3 | — | — | — | — | — | — | 2 | 5 | — | — | — | 5 |
| C | C-1 | 80 | 75 | — | — | 85 | — | 20 | — | — | — | 80 | — |
| | C-2 | — | — | — | — | — | — | — | 40 | — | — | — | — |
| | C-3 | — | — | 80 | 80 | — | 60 | 60 | 40 | — | — | — | — |
| Water | | rest | rest | rest | rest | rest | rest | rest | rest | rest | rest | rest | rest |
| Total | | 100 | 100 | 100 | 100 | 100 | 100 | 100 | 100 | 100 | 100 | 100 | 100 |
| Measured | pH (in 10% aqueous solution) | 13.1 | 12.8 | 12.6 | 12.5 | 12.7 | 12.8 | 12.3 | 12.9 | 13.2 | 12.8 | 12.8 | 12.6 |
| values | Viscosity (mm²/s, 25° C.) | 15 | 12 | 6 | 7 | 15 | 5 | 7 | 10 | 50 | 4 | 12 | 5 |
| Evaluation | Stripping effect to alignment film | | | | | | | | | | | | |
| results | (dipping time = 1 min) | 5 | 4 | 5 | 4 | 5 | 4 | 5 | 5 | 3 | 2 | 2 | 2 |
| | (dipping time = 2 min) | 5 | 5 | 5 | 5 | 5 | 5 | 5 | 5 | 3 | 2 | 2 | 2 |
| | (dipping time = 30 min) | 5 | 5 | 5 | 5 | 5 | 5 | 5 | 5 | 5 | 4 | 4 | 4 |
| | Stripping effect to photoresist | | | | | | | | | | | | |
| | (dipping time = 1 min) | 5 | 4 | 4 | 5 | 4 | 4 | 5 | 5 | 2 | 2 | 2 | 2 |
| | (dipping time = 2 min) | 5 | 5 | 5 | 5 | 5 | 5 | 5 | 5 | 2 | 2 | 2 | 3 |
| | (dipping time = 30 min) | 5 | 5 | 5 | 5 | 5 | 5 | 5 | 5 | 3 | 4 | 4 | 4 |
| | Corrosion prevention effect | >36 | >36 | >36 | >36 | >36 | >36 | >36 | >36 | 5 | 2 | 2 | 5 |
| | (corrosion time: hour) | | | | | | | | | | | | |
| | Corrosion rate (mdd, 50° C.) | 2 | 4 | 3 | 4 | 3 | 3 | 2 | 5 | 10 | 20 | 20 | 15 |

Utility in the Industry

Because the cleaner of this invention is superior in preventing Al-corrosion as well as in the removal effect to oil, finger print, resin and particles, it not only can be used to clean electronic parts like glass substrate of LCD panel and semiconductor silicon substrate, etc., but also is suitably used to clean electric parts, metal parts and building materials. Therefore, the cleaner of this invention is quite useful in the industry.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. An alkali cleaner, comprising:
an alkali component (A);
a polyvalent alcohol (B) of 3 to 8 valent, containing no nitrogen atom and having a number average molecular weight of 92-400; and
an alcohol (C) comprising at least one alcohol selected from the group consisting of a divalent alcohol (C1) containing no nitrogen atom and having a number average molecular weight of 62-250 and a monovalent alcohol (C2) containing no nitrogen atom and having a number average molecular weight of 32-500.

2. The alkali cleaner of claim 1, wherein the alkali component (A) comprises an organic alkali expressed by a general formula (1): 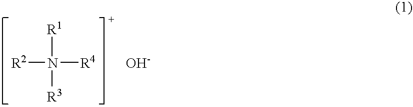
—(R⁵O)ₚ—H (2)
wherein R¹ represents a hydrocarbon group having a carbon number of 1-24 and each of R², R³ and R⁴ represents a hydrogen atom, a hydrocarbon group having a carbon number of 1-24 or a group expressed by a general formula (2), wherein R⁵ is an alkylene group having a carbon number of 2-4 and p is an integer of 1-6.

3. The alkali cleaner of claim 1, wherein the alkali component (A) comprises tetraalkylammonium hydroxide, wherein each alkyl group has a carbon number of 1 or 2.

4. The alkali cleaner of claim 1, wherein on the basis of a total amount of (A), (B) and (C), the alkali component (A) has an amount of 0.1-25 wt %, the polyvalent alcohol (B) has an amount of 1-25 wt % and the alcohol (C) has an amount of 60-95 wt %.

5. The alkali cleaner of claim 1, further comprising at least one of a surfactant (D), a hydrophilic solvent (E) containing an amide group, an anti-rust agent, an antioxidant, a metal ion chelating agent and water.

6. The alkali cleaner of claim 5, wherein the water has an amount of 2-30 wt % on the basis of a total amount of the alkali cleaner.

7. The alkali cleaner of claim 1, which has a corrosion rate lower than 10 mdd to aluminum at 50° C.

8. A method for cleaning an electronic part, an electric part or an aluminum building material, comprising:
using the alkali cleaner of claim 1 and at least one cleaning method selected from ultrasonic cleaning, shower cleaning, spray cleaning, dipping cleaning and dipping-shaking cleaning.

9. The method of claim 8, wherein the electronic part comprises a glass substrate or a silicon substrate.

10. The method of claim 9, wherein the glass substrate or the silicon substrate has at least one portion using aluminum.

11. An electronic part, an electric part or an aluminum building material that has been cleaned with the method of claim 8, rinsed, and then dried.
